(19) United States
(12) Patent Application Publication
(10) Pub. No.: US 2008/0018583 A1
(43) Pub. Date: Jan. 24, 2008

(54) Non-Rectangular Display Device

(75) Inventors: Alan G. Knapp, Crawley (GB); Stephen J. Battersby, Haywards Heath (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,447

(22) PCT Filed: May 25, 2005
(86) PCT No.: PCT/IB05/51713

§ 371 Date: Nov. 21, 2006

(30) Foreign Application Priority Data
May 28, 2004 (GB) 0411970.7

(51) Int. Cl. G02F 1/1345; G09G 3/36

(52) U.S. Cl. 345/99; 345/84; 345/87

(57) ABSTRACT

A display device comprises a substrate; an array of display pixels arranged on the substrate in rows and columns, a first and last row being at the top and bottom of the array, the outer shape of the array being nonrectangular; a plurality of row conductors, each row conductor being connected to a respective row of pixels, and a plurality of column conductors, each column conductor being connected to a respective column of pixels, the column conductors extending outside the array; and a plurality of row conductor spurs, each row conductor spur being parallel to the column conductors and extending from a respective row conductor, wherein the spur for the first row extends to the outside of the array; the spurs for the second row to an intermediate row extend to one side of the spur for the first row; and the spurs for the row after the intermediate row to the last row extend to the other side of the spur for the first row.

This invention relates to non-rectangular display devices. In particular, this invention relates to an addressing scheme for non-rectangular display devices that are addressed by a matrix of row and column conductors.

Display devices that are addressed by a matrix of row and column conductors are well known. One such example is an active matrix liquid crystal display (LCD) device. Active matrix LCD devices are used in an increasingly wide variety of products including consumer electronics, computers, industrial machinery and communications devices.

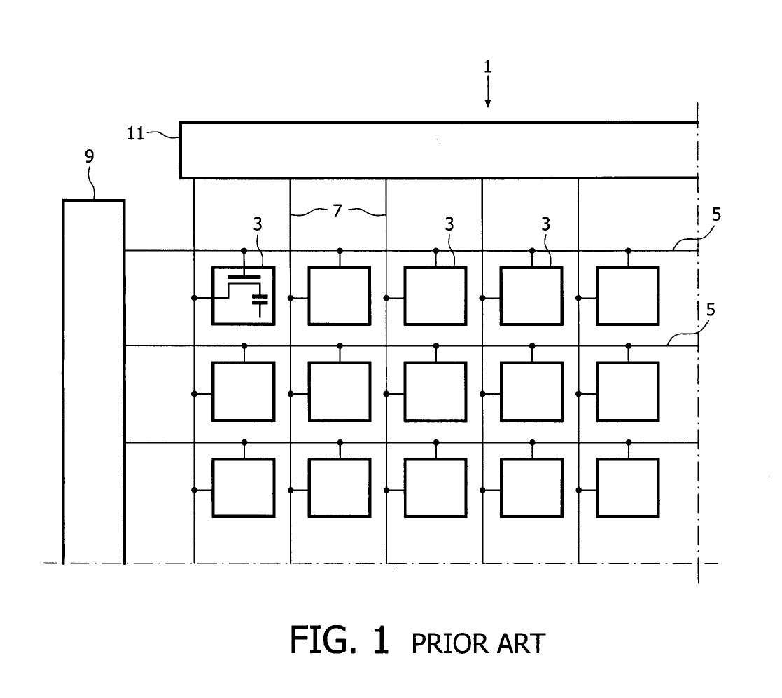

A typical active matrix LCD device is shown schematically in FIG. 1. The device 1 comprises a flat panel having a matrix array of regularly spaced pixels 3 arranged in rows and columns. Only a few of the pixels are shown for simplicity. Each pixel 3 comprises a liquid crystal (LC) cell, an associated switching means such as a thin film transistor (TFT), and a charge storage device such as a capacitor. The structure of only one pixel is shown for simplicity. Each row of pixels shares a common row conductor 5, and each column of pixels shares a common column conductor 7. The respective sets of row and column conductors 5, 7 are connected to a row (scanning) driver circuit 9 and a column (data) driver circuit 11. The driver circuits 9, 11 are implemented as integrated circuits and mounted on a peripheral region of the flat panel.

In use, a pixel 3 is driven to a required grey level by an appropriate signal provided on the associated column conductor 7 in synchronism with a row address pulse on the associated row conductor 5. The row address pulse turns on the TFT, thereby allowing the column conductor to charge the LC cell and capacitor to the appropriate level. At the end of the row address pulse, the charge on the LC cell is maintained by the capacitor. The rows of pixels are addressed sequentially so that all rows are addressed in one frame period, and refreshed in subsequent frame periods.

Conventional display devices are rectangular in shape, and this enables all of the pixels in the display to be addressed by a single row driver circuit and a single address driver circuit. However, product designers now wish to incorporate non-rectangular display devices into products so that an edge of a display area may closely follow a curved external surface of a product casing, and this requires modified addressing schemes. This is especially the case for small styled products requiring large display areas. Accordingly, there is a need for non-rectangular display devices having a small peripheral non-display area to accommodate driver circuitry and connections.

WO 03/102905 discloses an addressing scheme for a non-rectangular display in which the row and column conductors are addressed by a plurality of row and column driver portions distributed alternately around the periphery of the display device. Although this approach enables a reduction in the area of the display device that accommodates the addressing circuitry and connections, these parts of the device still consume a significant peripheral area. This peripheral area does not form part of the display area.

US 2002/0075440 discloses an addressing scheme for a non-rectangular display in which the row and column conductors are addressed from the same side of the array. This is accomplished by providing spurs that are electrically connected to the row conductors and that run parallel to the column conductors. The driver circuitry and connections may then be provided in a single area of the periphery, the row conductors being connected via the spurs. US 2002/0075440 does not consider the addressing implications of such arrangements.

According to a first aspect of the invention, there is provided a display device comprising:

a substrate;

an array of display pixels arranged on the substrate in rows and columns, a first and last row being at the top and bottom of the array, the outer shape of the array being non-rectangular;

a plurality of row conductors, each row conductor being connected to a respective row of pixels, and a plurality of column conductors, each column conductor being connected to a respective column of pixels, the column conductors extending outside the array; and

a plurality of row conductor spurs, each row conductor spur being parallel to the column conductors and extending from a respective row conductor to the outside of the array, wherein

the spurs for the second row to an intermediate row extend to one side of the spur for the first row; and

the spurs for the row after the intermediate row to the last row extend to the other side of the spur for the first row.

The invention thus provides a display device employing parallel addressing to column conductors and row conductor spurs. The row conductor spurs run in the same direction as the column conductors and are connected to respective row conductors. A spur connected to the first row conductor is not provided at a side of the array, but is instead provided in a central region, with spurs for subsequent row conductors being distributed to either side of the spur for the first row conductor. Such an arrangement allows for parallel addressing in non-rectangular display shapes, since it is not necessary for the first row conductor to extend all the way to a side of the array. Instead, the spur connected to the first row conductor may be arranged at any location along the first row conductor.

The length of the first row of pixels may be less than a length of a longest row of pixels. Non-rectangular displays having such a shape are easily implemented according to the invention.

Each spur is preferably adjacent to the spur for an adjacent row. In this arrangement, the spurs run in the same sequential order as the row conductors to which they are connected. However, the spurs are displaced relative to their respective row conductors by a fixed offset. Consequently, the addressing timing implications of the device according to the invention are minimised. The device may be addressed using conventional row and driver circuitry, but with the output of a row driver delayed in time relative to the output of a column driver. In this way, complex crossover arrangements for rearranging the order of the spurs, which may cause undesirable electrical effects, may be avoided while still avoiding any requirement for completely redesigned row and column driver circuitry. Crossover arrangements may or may not remain necessary to separate the row conductor spurs from the column conductors.

Preferably, the row conductors do not extend outside the array. Such an arrangement minimises the non-display peripheral area of the device.

Preferably, the spur connected to the first row conductor is within a central third of the spurs. Such an arrangement provides significant design freedom in respect of the shape of the array, since the outer thirds of the width of the display need not extend all the way up to the first row of pixels, i.e. the first row of pixels need not extend across the full width of the display.

The device preferably comprises N row conductors and spurs, a first and Nth spur being at opposite sides of the array. The first to kth spurs are preferably connected to rows (N−k+1) to N, where k is a positive integer. The (k+1)th to Nth spurs are preferably connected to rows 1 to (N−k).

k is preferably in the range 0.25N to 0.75N, and more preferably in the range 0.25N to 0.50N.

The device preferably further comprises row and column driver circuitry arranged outside the array and connected to the column conductors and spurs. The row and column driver circuitry is preferably connected to the column conductors and the spurs via a fan-out region of conductive tracks.

Preferably, the row and column driver circuitry comprises one or more integrated circuits. Alternatively, the row and column driver circuitry may be implemented directly on the substrate.

The row and column driver circuitry is preferably arranged to provide an addressing pulse for each row conductor in turn to a corresponding spur, and simultaneously provide data to the column conductors for the respective rows of pixels.

Preferably, the row and column driver circuitry is arranged to provide the addressing pulse for the first to last row conductor in turn in response to a row driver start pulse, and the row and column driver circuitry further comprises a delay element arranged to delay the row start pulse relative to the data provided to the column conductors.

The device is preferably an active matrix liquid crystal display device.

The invention also provides a method of driving a display device, the display device comprising:

a substrate;

an array of display pixels arranged on the substrate in rows and columns, a first and last row being at the top and bottom of the array respectively, the outer shape of the array being non-rectangular;

a number N of row conductors, each row conductor being connected to a respective row of pixels, and a plurality of column conductors, each column conductor being connected to a respective column of pixels, the column conductors extending outside the array; and

the number N of row conductor spurs, each row conductor spur being parallel to the column conductors and extending from a respective row conductor to the outside of the array, wherein the spurs for the second row to an intermediate row extend to one side of the spur for the first row; and the spurs for the row after the intermediate row to the last row extend to the other side of the spur for the first row,

the method comprising the steps of:

(a) for the (k+1)th to Nth spurs, providing an addressing signal to the spurs in turn and simultaneously providing data for the first to (N−k)th row of pixels in turn to the column conductors;

(b) for the first to kth spurs, providing an addressing signal to the spurs in turn and simultaneously providing data for the (N−k+1) to Nth row of pixels in turn to the column conductors; and

(c) repeating steps (a) and (b) for each frame of data.

By way of example, a preferred embodiment of the invention will now be described in detail with reference to the accompanying drawings in which:

FIG. 1 schematically shows a known display device;

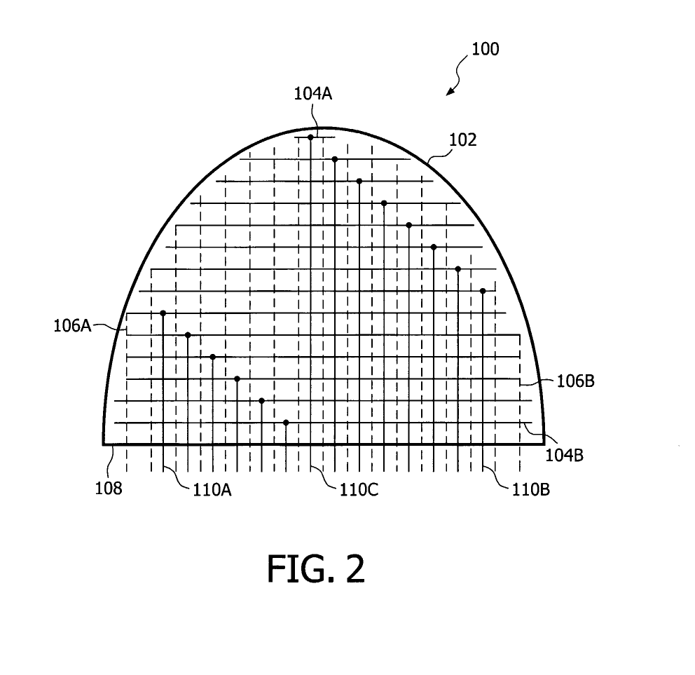

FIG. 2 shows a display device according to the invention;

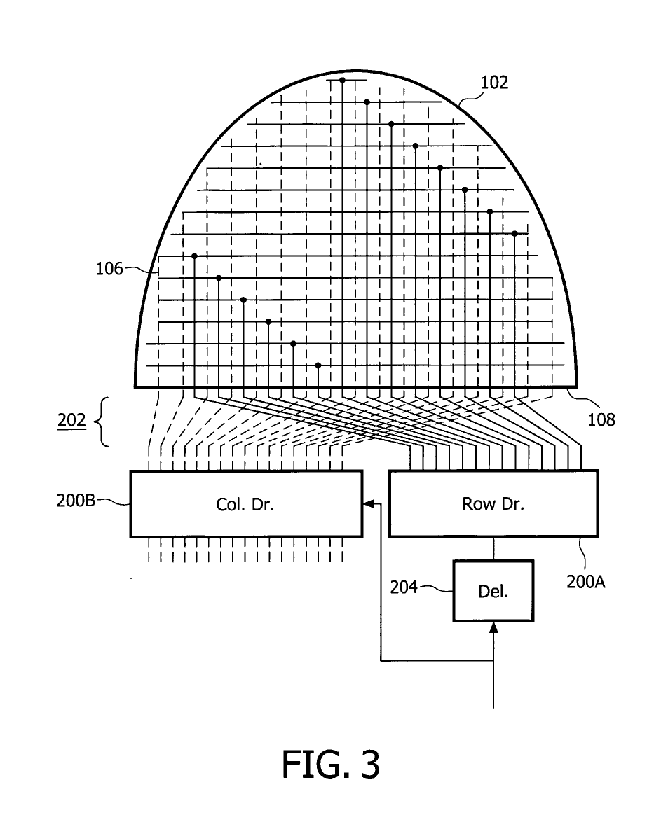

FIG. 3 shows the display device shown in FIG. 2 having row and column driver circuitry; and

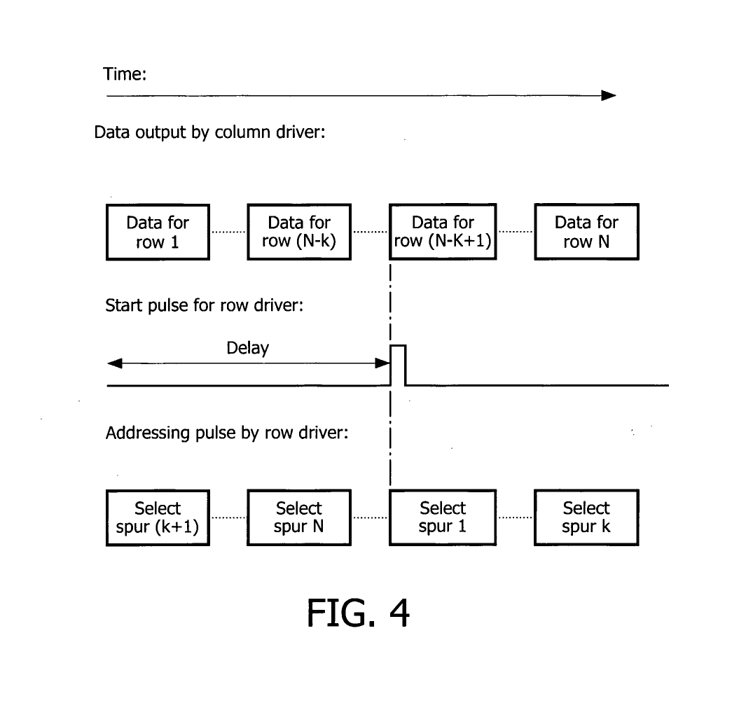

FIG. 4 shows a timing chart for the display device shown in FIG. 3.

This invention relates to the addressing of non-rectangular displays using an array of row and column conductors.

FIG. 2 shows a display device according to the invention. The device 100 comprises a non-rectangular array 102 of display pixels arranged on a substrate in rows and columns. In the example, the array is “D” shaped with a longer curved side and a shorter flat side. However, the array may have any appropriate non-rectangular shape. For example, the flat side of the array shown in the Figure may in fact have slight curvature to it. The first row and the last row are located at the top and bottom of the array.

The device also comprises a plurality of row conductors 104 each connected to a respective row of pixels. For example, the first row of pixels is connected to row conductor 104A and the last row of pixels is connected to row conductor 104B. Similarly, the device also comprises a plurality of column conductors 106 each connected to a respective column of pixels. For example, the first column of pixels is connected to column conductor 106A and the last column of pixels is connected to column conductor 106B.

The column conductors 106 extend outside an edge 108 of the array 102 at one of their ends, and these ends are connected to column driver circuitry, which will be described later. The row conductors 104 do not extend outside the array 102 at either of their ends, and this ensures that a non-display peripheral area of the device is minimised.

The row conductors 104 are connected to row driver circuitry (not shown) via respective row conductor spurs 110. The row conductor spurs extend in the same direction as the column conductors 106. One end of each row conductor spur 110 is connected to a different row conductor 104. The other end of the row conductor spurs 110 extend outside the edge 108 of the array 102 and provide the connection to the row driver circuitry, which will be described later.

The row conductor spurs run from a first spur 110A at one side of the display to a last spur 110B at the opposite side of the display. In the example the spurs run from left to right, but may alternatively run from right to left.

The first row conductor 104A is connected to a middle order row conductor spur 110C substantially in the centre of the array 102. The particular spur 110C to which the first row conductor 104A is connected is dictated by the position and length of the first row conductor 104A. In the example, the first row conductor 104A is located in the centre of the array 102 and is short. Consequently, the spur 110C connected to the first row conductor 104A is also provided in the centre of the array 102. The longer the first row conductor 104A, the greater the design flexibility there is in determining the position of the spur 110C.

The second row conductor is connected to a spur adjacent to the middle row conductor spur 110C. In the example this is the row conductor spur immediately to the right of the middle spur 110C, but may alternatively be the spur immediately to the left. The spurs to the right are connected to subsequent row conductors in a similar fashion, so that each spur is adjacent to the spur for an adjacent row conductor. The number of spurs 110 to the right of the spur 110C depends on the location in the array of spur 110C. Typically, this will be around half of the total number of spurs 110 required for all of the row conductors 104.

The remaining spurs 110 are provided to the left of the middle spur 110C. Again the spurs 110 are connected to row conductors 104 so that each spur is adjacent to the spur for an adjacent row conductor.

The arrangement of row conductor spurs according to the invention allows for non-rectangular displays, since there is no requirement for the first row conductor to extend to any particular location in the array. Instead, the row conductor spur is positioned adjacent the first row conductor and subsequent row conductor spurs are arranged accordingly.

For a display comprising N row conductors and spurs, the first to kth spurs are connected to rows (N−k+1) to N, where k is a positive integer. The (k+1)th to Nth spurs are then connected to rows 1 to (N−k). The positive integer k corresponds to the number of row conductor spurs preceding the spur connected to the first row conductor.

FIG. 3 shows the display device shown in FIG. 2, but with row and column driver circuitry 200. The row and column driver circuitry comprises a row driver integrated circuit 200A and a column driver integrated circuit 200B. The column conductors 106 and row conductor spurs 110 that extend across the edge 108 of the array 102 are gathered separately in a fan-out region 202 of the display device and connected to the row driver integrated circuit 200A and the column driver integrated circuit 200B. Although separate integrated circuits are shown, the row and column driver circuitry may be integrated into a single integrated circuit and, in this case, gathering of the column conductors and column conductor spurs may or may not be required.

The spurs 110 run in the same sequential order as the row conductors 104 to which they are connected. However, the spurs 110 are displaced relative to their respective row conductors 104 by a fixed offset. The display may therefore be addressed using conventional row and driver circuitry, but with the output of the row driver circuitry delayed in time relative to the output of the column driver circuitry. The delay of the row driver circuitry corresponds to the fixed offset of the spurs 110 and is provided by delay element 204. In this way, the addressing timing implications of the device according to the invention are minimised.

A row start pulse controls the driving circuitry in integrated circuits 200A and 200B. In particular, the rising edge of the row start pulse triggers the row driving circuitry to start scanning, i.e. sequentially selecting each of the row conductors.

The offset in the spurs 110 relative to the row conductors 104 can be compensated for by delaying the timing of the row driver circuitry scanning relative to the data being provided by the column driver circuitry.

Accordingly, conventional driver circuitry with minimal modifications may be used to drive the display device according to the invention.

FIG. 4 shows a timing chart for the display device shown in FIG. 3. The chart shows the relative timings of the delayed row start pulse, the row driver scanning and the data output by the column driver. It can be seen from the timing chart that the delayed row start pulse causes the timing of selection of rows conductor spurs by the row driver to be delayed with respect to the timing of data provided to the columns by the column driver. This delayed timing compensates for the connection relationship between the spurs and the row conductors and ensures that the correct data is provided to the column conductors when a particular spur/row conductor combination is selected/addressed.

The terms “row” and “column” are somewhat arbitrary in the description and claims. These terms are intended to clarify that there is an array of elements with orthogonal lines of elements sharing common connections. Although a row is normally considered to run from side to side of a display and a column to run from top to bottom, the use of these terms is not intended to be limiting in this respect.

The invention has been described with reference to an active matrix LCD display device. However, the invention may be applied to any type of display device having pixels and intersecting orthogonal conductors. Thus, the invention could be applied to electroluminescent display devices.

The row and column driver circuitry of the example described above comprise integrated circuits. However, row and column driver circuitry may alternatively be formed on the same substrate as the display pixels, for example the pixels and driver circuitry may be formed using polysilicon processing technology. Alternatively, the driver circuit portions may be on a different substrate or substrates to the display area.

Other features of the invention will be apparent to those skilled in the art.

1. A display device comprising:
a substrate;
an array of display pixels arranged on the substrate in rows and columns, a first (104A) and last (104B) row being at the top and bottom of the array, the outer shape (102) of the array being non-rectangular;
a plurality of row conductors (104), each row conductor being connected to a respective row of pixels, and a plurality of column conductors (106), each column conductor being connected to a respective column of pixels, the column conductors extending outside the array; and
a plurality of row conductor spurs (110), each row conductor spur (110) being parallel to the column conductors (106) and extending from a respective row conductor (104) to the outside of the array, wherein
the spurs for the second row to an intermediate row (110B) extend to one side of the spur (110C) for the first row; and
the spurs for the row after the intermediate row (110A) to the last row extend to the other side of the spur (110C) for the first row.

2. The device of claim 1, wherein the length of the first row (104A) of pixels is less than a length of a longest row of pixels (104B).

3. The device of claim 1, wherein each spur (110) is adjacent to the spur for an adjacent row.

4. The device of claim 1, wherein the row conductors (104) do not extend outside the array.

5. The device of claim 1, wherein the spur (110C) for the first row is within a central third of the spurs (110).

6. The device of claim 1, comprising N row conductors (104) and spurs (110), wherein the first (110A) to kth spurs are connected to rows (N−k+1) to N, where k is a positive integer, and the (k+1)th (110C) to Nth (110B) spurs are connected to rows 1 to (N−k).

7. The device of claim 6, wherein k is in the range 0.25N to 0.75N.

8. The device of claim 6, wherein k is in the range 0.25N to 0.50N.

9. The device of claim 1 further comprising row and column driver circuitry (200a, 200B) arranged outside the array and connected to the column conductors (106) and spurs (110).

10. The device of claim 9, wherein the row and column driver circuitry (200A, 200B) comprises one or more integrated circuits.

11. The device of claim 9, wherein the row and column driver circuitry (200A, 200B) is arranged to provide an addressing pulse for each row conductor in turn to a corresponding spur, and simultaneously provide data to the column conductors for the respective rows of pixels.

12. The device of claim 11, wherein the row and column driver circuitry is arranged to provide addressing pulses for the first to last row conductors in turn in response to a row driver start pulse, and wherein the row and column driver circuitry further comprises a delay element (204) arranged to delay the row start pulse relative to the data provided to the column conductors.

13. The device of claim 1, wherein the device is an active matrix liquid crystal display device.

14. A method of driving a display device, the display device comprising:
a substrate;
an array of display pixels arranged on the substrate in rows (104) and columns (106), a first and last row being at the top and bottom of the array respectively, the outer shape of the array being non-rectangular;
a number N of row conductors (104), each row conductor being connected to a respective row of pixels, and a plurality of column conductors (106), each column conductor being connected to a respective column of pixels, the column conductors extending outside the array; and
the number N of row conductor spurs (110), each row conductor spur being parallel to the column conductors and extending from a respective row conductor to the outside of the array, wherein the spurs for the second row to an intermediate row extend to one side of the spur (110C) for the first row (104A); and the spurs for the row after the intermediate row to the last row (104B) extend to the other side of the spur (110C) for the first row,
the method comprising the steps of:
(a) for the (k+1)th to Nth spurs, providing an addressing signal to the spurs in turn and simultaneously providing data for the first to (N−k)th row of pixels in turn to the column conductors;
(b) for the first to kth spurs, providing an addressing signal to the spurs in turn and simultaneously providing data for the (N−k+1) to Nth row of pixels in turn to the column conductors; and
(c) repeating steps (a) and (b) for each frame of data.
